(19) United States
(12) Patent Application Publication
(10) Pub. No.: US 2022/0404675 A1
(43) Pub. Date: Dec. 22, 2022

(54) ULTRATHIN ELECTROCHROMIC ELEMENT AND DEVICE FOR HIGH OPTICAL MODULATION

(71) Applicant: NITTO DENKO CORPORATION, Osaka (JP)

(72) Inventor: Liping Ma, San Diego, CA (US)

(21) Appl. No.: 17/775,541

(22) PCT Filed: Nov. 9, 2020
(86) PCT No.: PCT/US2020/059738

§ 371 Date: May 9, 2022

Related U.S. Application Data
(60) Provisional application No. 62/933,132, filed on Nov. 8, 2019.

(51) Int. Cl. G02F 1/1524; G02F 1/155

(52) U.S. Cl. CPC G02F 1/1524; G02F 1/155; G02F 2001/15145

(57) ABSTRACT

The present disclosure relates to electrochromic devices including an insulating layer and at least one electrochromic material having one or more optical properties that may be changed upon application of an electric potential. The device may include a conductive nanoparticle layer and/or a buffer layer. Upon provision of an electric potential above a threshold, electrons and holes may be injected into the electrochromic material and blocked by the insulating layer, resulting in an accumulation of the electrons and holes in their respective electrochromic material resulting in a change to the one or more optical properties of the electrochromic material. An opposite electric potential may be provided to reverse the change in the one or more optical properties.

### FIELD

The present disclosure relates to electrochromic elements and devices comprising an insulating layer and electrochromic materials having one or more optical properties that may be changed from a first optical property state to a second optical property state upon application of an electric potential.

### BACKGROUND

Electrochromic coatings or materials may be used for several different purposes. One such purpose includes controlling the amount of light and heat passing through a window based on a user-controlled electrical potential that is applied to an electrochromic coating. An electrochromic coating or material can reduce the amount of energy necessary to heat or cool a room and can provide privacy. For example, a clear state of the electrochromic coating or material, having an optical transmission of about 60-80%, can be switched to a darkened state, having an optical transmission of between 0.1-10%, where the energy flow into the room is limited and additional privacy is provided. Due to large amounts of glass found in various types of windows, such as skylights, aircraft windows, automobile windows, and residential and commercial building windows, there may be energy savings provided by the use of an electrochromic coating or material on glass.

Despite the potential benefits that an electrochromic coating or device may provide, various issues may make current electrochromic devices undesirable for some applications. For example, in electrochromic devices utilizing an electrolyte, low ion mobility of the electrolyte may cause reductions in switching speeds and temperature-dependence issues. Ion intercalation may also occur in the electrochromic layer of an electrolyte-based device which causes the device volume to expand, and resultant mechanical stresses may limit the ability to operate between on and off cycles of the device. In such devices, there is a trade-off between high-speed switching and uniform switching because high ion mobility gives a very low internal device resistance for a larger area device, and this may lead to non-uniformity in application of an electric field across the whole device area. A further limitation of some electrochromic devices is the need for continuous application of electrical power in order to retain changes to the optical properties of the electrochromic material. Thus, there remains a need for further contributions in this area of technology.

### SUMMARY

Disclosed herein are electrochromic devices, which include an electrochromic element having one or more optical properties that can change from a first state to a second state upon application of an electric potential. The present disclosure also describes electrochromic devices having a blocking layer that exhibits insulative properties intended for retaining changes to the optical properties of the electrochromic material following application of the electric potential.

Some embodiments include an electrochromic element comprising a first electrode layer, wherein the first electrode layer comprises a transparent conductive material. Some embodiments include a first electrochromic layer; wherein the first electrochromic layer comprises a p-type electrochromic based composite comprising a p-type electrochromic material and an inorganic material additive comprising an inorganic oxide. In some embodiments, the first electrochromic layer is in electrical communication with the first electrode layer. Some embodiments include an insulating layer; wherein the insulating layer comprises an electrically insulating material with a band gap at least 5 eV. In some embodiments, the electrically insulating material is in electrical communication with the first electrochromic layer. Some embodiments include a second electrochromic layer; wherein the second electrochromic layer comprises an n-type electrochromic material. In some embodiments, the second electrochromic layer is in electrical communication with the insulating layer. Some embodiments include a second electrode layer; wherein the second electrode layer comprises a transparent conductive material. In some embodiments, the second electrode layer is in electrical communication with the second electrochromic layer.

Some embodiments include an electrochromic device comprising an electrochromic element described herein. In some embodiments the electrochromic device further comprises a power source, wherein the power source is in electrical communication with the first electrode layer and the second electrode layer to provide an electric voltage to the device.

In addition, the present disclosure provides methods for the preparation of the electrochromic elements and devices described herein.

### BRIEF DESCRIPTION OF THE DRAWINGS

FIG. 1 is a schematic illustration of one embodiment of an electrochromic element.

FIG. 2 is a schematic illustration of one embodiment of an electrochromic device.

FIG. 3 is an illustration showing the electron drift through the solid state electrolytic layer (Ta₂O₅) and accumulation of electrons and holes at the nickel oxide electrolytic interface of a conventional electrochromic device.

FIG. 4 is an illustration showing the electron blockage by a metal oxide insulating layer (Al₂O₃) allowing for the accumulation of electrons in the n-type electrochromic layer and holes in the p-type electrochromic layer in an electrochromic device with an insulating layer with a high band gap and a high conductance minimum band relative to the Fermi level.

FIG. 5 is an illustration showing the electron blockage by a metal nitride insulating layer (AlN) allowing for the accumulation of electrons in the n-type electrochromic layer and holes in the p-type electrochromic layer in an electrochromic device with an insulating layer with a high band gap and a low conductance minimum band relative to the Fermi level.

FIG. 6 is a graphic illustration showing the total transmission (T %) as a function of wavelength (nm) of the device of Example CE-1 in an ON state and OFF state.

FIG. 7 is a graphic illustration showing the total transmission (T %) after the accelerated stability test as a function of wavelength (nm) of a comparative embodiment of the device of example CE-1 in an ON state and OFF state.

FIG. 8 is a graphic illustration showing the total transmission (T %) as a function of wavelength (nm) of an alternative embodiment of the device of example EC-1 in an ON state and OFF state.

FIG. 9 is a graphic illustration showing the total transmission (T %) after the accelerated stability test as a function of wavelength (nm) of a comparative embodiment of the device of example EC-1 in an ON state and OFF state.

FIG. 10 is a graphic illustration showing the total transmission (T %) as a function of wavelength (nm) of an alternative embodiment of the device of example EC-2 in an ON state and OFF state.

FIG. 11 is a graphic illustration showing the total transmission (T %) after the accelerated stability test as a function of wavelength (nm) of a comparative embodiment of the device of example EC-2 in an ON state and OFF state.

FIG. 12 is an AFM image of the insulating layer of the comparative examples (CE-1).

FIG. 13 is a line graph depicting the surface profile one of the comparative example (CE-1).

FIG. 14 is an AFM image of the insulating layer of the comparative examples (CE-1) aged for two (2) weeks.

FIG. 15 is a line graph depicting the surface profile one of the comparative example (CE-1) aged for two (2) weeks.

FIG. 16 is an AFM image of the insulating layer of one of the embodiments of the present disclosure (EC-1).

FIG. 17 is a line graph depicting the surface profile one of one of the embodiments of the present disclosure (EC-1).

FIG. 18 is an AFM image of the insulating layer of one of the embodiments of the present disclosure (EC-1) aged for two (2) weeks.

FIG. 19 is a line graph depicting the surface profile one of one of the embodiments of the present disclosure (EC-1) aged for two (2) weeks.

### DETAILED DESCRIPTION

As used herein, the term “transparent” includes a property in which the corresponding material transmits or allows light to pass through the material. In one aspect, the transmittance of light through the transparent material may be about 50-100%, such as at least about 50%, at least about 60%, at least about 70%, at least about 80%, at least about 90%, at least about 95%, at least about 99%, about 50-60%, about 60-70%, about 70-80%, about 80-90%, about 90-95%, or about 95%-99%.

The term “light” as used herein includes light in a wavelength region targeted by the electrochromic element or device. For example, when the electrochromic material or device is used as a filter of an image pickup apparatus for a visible light region, light in the visible light region is targeted, and when the electrochromic material is used as a filter of an image pickup apparatus for an infrared region, light in the infrared region is targeted.

The term “darkness efficiency” as used herein includes the efficiency of the electrochromic element's/device's optical modulation ratio per unit of the electrochromic layer thickness represented by the following formula:

$$Darkness efficiency = \frac{T \% ( OFF - state ) / T \% ( ON - state )}{EC - layer thickness ( nm )}$$

wherein T % is the transmittance percentage in the off-state (clear state) and the on-state (dark state) and the EC layer thickness is the thickness of the electrochromic stack in nm.

The term “band gap” (energy gap) as used herein has its ordinary meaning in the art and a person of ordinary skill in the art would recognize the term as including the energy required, measured in electron volts (eV), to promote a bound valance electron to become a conductive electron free to move within a solid layer. The conductive electron can serve as a charge carrier to conduct electrical current.

The present disclosure generally relates to electrochromic elements and devices. The electrochromic devices herein include at least one electrochromic element having one or more optical properties, such as transparency, absorption, or transmittance, that may be changed from a first state to a second state upon application of an electric potential. More particularly, but not exclusively, the present disclosure relates to electrochromic elements and devices comprising ultrathin layers, exhibiting improved on- and off-state transmittance differentiation properties following application of the electric potential.

Generally, an electrochromic element comprises a first electrode and a second electrode. One or more blocking layers and one or more electrochromic layers may be disposed between the first electrode and the second electrode. In some cases, a conductive nanostructured metal layer may be disposed on an electrochromic layer. In some embodiments, a buffer layer may be present. Additional layers, such as a protection layer, may also be present in some embodiments of the electrochromic elements and devices disclosed herein.

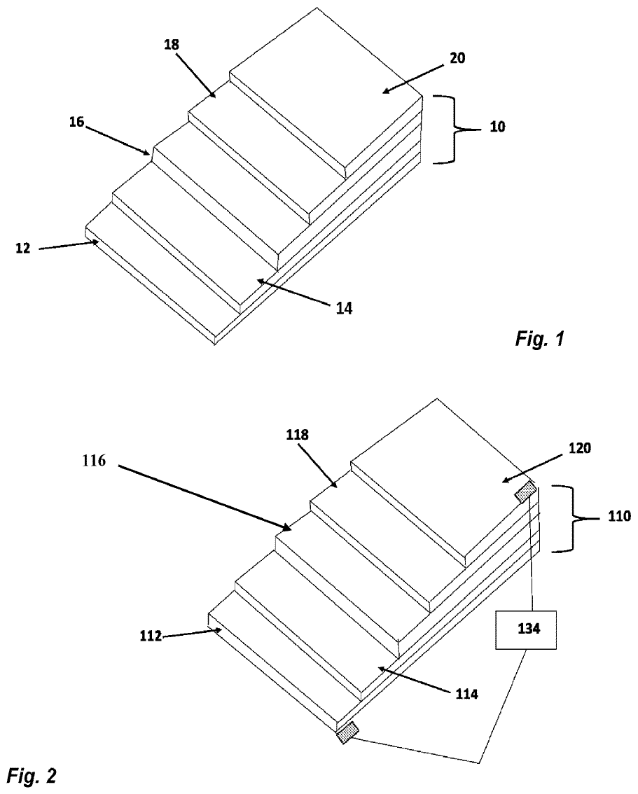

There are many potential configurations for the electrochromic element. One potentially useful configuration is depicted in FIG. 1. An electrochromic element, such as electrochromic element 10 in FIG. 1, comprises (e.g., in the order depicted, from bottom to top): a first electrode layer 12, which is a conductive layer; a first electrochromic layer 14 comprising an electrochromic material and an inorganic oxide; an insulating layer 16, which may also be termed a blocking layer, or a barrier layer and which comprises an electrically insulative material; a second electrochromic layer 18, comprising an electrochromic material; and a second electrode layer 20, which is a conductive material. In some examples, a buffer layer (not pictured) is positioned between the first electrode and the first electrochromic layer. In some embodiments, the layers of the electrochromic element are in electrical and optical communication with one another. In some embodiments, the electrochromic layers of the electrochromic element may change from a first state (clear or transparent) to a second state (colored or darkened).

In some embodiments, the recited layers of the element are disposed in the recited order from bottom to top. In some embodiments, the recited layers of the electrochromic element are contacting one another in that order from bottom to top. Alternative arrangements of the layers of the electrochromic element are also contemplated.

Generally, an electrochromic device comprises the electrochromic element described above, or elsewhere herein, and a power source in electrical communication with the first electrode and the second electrode, to provide an electric potential to the electrochromic device.

There are many potential configurations for the electrochromic device. One potentially useful configuration is depicted in FIG. 2. In FIG. 2, an electrochromic device, such as device 110, comprises (e.g., in the order depicted): a first electrode layer 112, which is a conductive layer; a first electrochromic layer 114, comprising an electrochromic material and an inorganic oxide; an insulating layer 116, which may also be termed a blocking layer, a barrier layer or a tunneling layer, and which comprises an electrically insulative material; a second electrochromic layer 118, comprising an electrochromic material; a second electrode layer 120, which is a conductive material; and a power source, such as power source 134, which is in electrical communication with the first electrode and the second electrode. In some examples, a buffer layer (not pictured) is positioned between the first electrode and the first electrochromic layer. In some embodiments, the layers of the electrochromic device are in electrical and optical communication with one another. In some embodiments, the electrochromic layers of the electrochromic device may change from a first state (clear or transparent) to a second state (colored or darkened). In some embodiments, the electrochromic device can further comprise a protective layer (not shown).

In some embodiments, the layers of the device are disposed in the recited order from bottom to top. In some embodiments, the layers of the electrochromic device are contacting one another in that order from bottom to top. In some embodiments, the layers of the device are contacting one another in that order from top to bottom. Alternative arrangements of the layers of the electrochromic device are also contemplated.

The electrochromic elements and devices described herein comprise an electrode on, or adjacent to, the top and the bottom of the various electrochromic element or device layers. In some embodiments, the electrodes (“electrodes,” “the electrodes,” or a similar phrase is used as shorthand herein for “first electrode and/or second electrode”) may be formed on a bonding layer and/or a substrate. The electrodes may comprise a transparent material, which may also be conductive. When one or more of the electrodes are transparent, light and energy can be efficiently transmitted to the inner layers of the element or device and may interact with the electrochromic materials and other layers within the element or device.

In some embodiments, the electrochromic elements comprise a first electrode layer and a second electrode layer. The first electrode and the second electrode may be defined in their entirety by the electrode(s) found in these layers, or it is possible that the electrodes of these layers only partially define these layers. In some embodiments, the electrodes of these layers may be formed on a bonding layer and/or substrate. In some embodiments, the remainder of the electrode layers, wherein the electrodes only partially define these layers, may be formed of a transparent material. In some examples, when one or more of the electrodes and layers are transparent, light can be efficiently taken in from the outside of layers to interact with the electrochromic material of the electrochromic element and enables optical modulation of the electrochromic material on emitted light.

In some examples, the electrodes may comprise a transparent conductive oxide, dispersed carbon nanotubes on a transparent substrate, partly arranging metal wires on a transparent substrate, or combinations thereof. In some embodiments, the electrodes may be formed from a transparent conductive oxide material having good transmissivity and conductivity, such as tin-doped indium oxide (also called indium tin oxide, or ITO), zinc oxide, gallium-doped zinc oxide (GZO), indium zinc oxide (IZO), aluminum-doped zinc oxide (AZO), tin oxide, antimony-doped tin oxide (ATO), fluorine-doped tin oxide (FTO), niobium-doped titanium oxide (TNO), a conductive polymer material, or a material containing Ag, Ag nanoparticles, carbon nanotubes or graphene. Of the transparent conductive oxide materials identified above, FTO may be selected for heat resistance, reduction resistance, and conductivity and ITO may be selected for conductivity and transparency. In the event a porous electrode is formed and calcined, then the transparent conductive oxide, if used, preferably has high heat resistance. One or more of the electrodes may contain one of these materials, or one or more of the electrodes may have a multi-layer structure containing a plurality of these materials. In an alternative form, one or more of the electrodes may be formed from a reflective material such as a Group 10 of 11 metal, non-limiting examples of which include Au, Ag, and/or Pt. Forms in which the reflective material is a Group 13 metal, such as aluminum (Al) are also possible.

In some embodiments, the first electrode is indium tin oxide. In some examples, the thickness of the first electrode (e.g., an ITO electrode) is about 10 nm to about 300 nm, about 10-12 nm, about 12-14 nm, about 14-16 nm, about 16-18 nm, about 18-20 nm, about 20-22 nm, about 22-24 nm, about 24-26 nm, about 26-28 nm, about 28-30 nm, about 30-35 nm, about 35-40 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 75-85 nm, about 15-25 nm, about 1-50 nm, about 50-100 nm, about 100-150 nm, about 80 nm, about 20 nm, about 185 nm, or about any thickness bounded by any of the above ranges. In some embodiments, the first electrode is a pre-learned patterned ITO-glass substrate.

In some embodiments, the second electrode is indium tin oxide. In some examples, the thickness of the second electrode (e.g., an ITO electrode) is about 10 nm to about 150 nm, about 10-12 nm, about 12-14 nm, about 14-16 nm, about 16-18 nm, about 18-20 nm, about 20-22 nm, about 22-24 nm, about 24-26 nm, about 26-28 nm, about 28-30 nm, about 30-35 nm, about 35-40 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 15-25 nm, about 1-50 nm, about 50-100 nm, about 100-150 nm, about 80 nm, or about 20 nm.

The second electrode layer may comprise a nanostructured surface morphology complementary to the corresponding nanostructured surface morphology of the buffer layer (or first electrochromic layer) projecting through the ultrathin layers of the present disclosure, as discussed in greater detail below.

Some embodiments include electrochromic elements or electrochromic devices comprising one or more electrochromic layers. The electrochromic layers of the elements and devices described herein can comprise electrochromic materials containing charge sensitive materials. In some embodiments, the electrochromic layers of the electrochromic element or device comprise one or more optical properties that may change from a first state (clear or transparent) to a second state (colored or darkened) upon the application of an electric potential. In some embodiments, the electrochromic material of the first electrochromic layer can include p-type electrochromic materials. As used herein, the term “p-type electrochromic material” refers to a material in which its Fermi energy level (E_{f}) is closer to the valence band energy level (Eᵥ) than its conductance band energy level (E_{c}). In some embodiments, the electrochromic material of the second electrochromic layer can include n-type electrochromic materials. As used herein, the term “n-type electrochromic material” means the refers to a material in which its Fermi energy level (E_{f}) is closer to the conductance band energy level (E_{c}) than its valance band energy level (Eᵥ).

Table 1 illustrates some electrochromic materials' E_{c}, Eᵥ, and E_{f}. This table is only for illustrative purposes and in no way is intended to limit which electrochromic materials that can be used in the current element.

TABLE 1

| | MoO₃ | V₂O₅ | WO₃ | Ta₂O₅ | NiO |
|---|---|---|---|---|---|
| E_{c} (eV) | −6.7 | −6.7 | −6.5 | −4.03 | −2.1 |
| Eᵥ (eV) | −9.7 | −9.5 | −9.8 | −7.93 | −5.3 |
| E_{f} (eV) | −6.9 | −7.0 | −6.7 | −4.45 | −4.7 |
| Material Type | n-type | n-type | n-type | n-type | p-type |

In some embodiments, the first electrochromic layer may comprise p-type electrochromic-based composite materials. In some embodiments, the p-type electrochromic-based composite may comprise a p-type electrochromic material and an additive material comprising an inorganic oxide. The term “p-type electrochromic material” or similar term is used as shorthand for “p-type electrochromic material” or “p-type electrochromic-based composite”; a “p-type electrochromic-based composite” comprises a p-type electrochromic material an additive material comprising an inorganic oxide. In some embodiments, the first electrochromic layer may comprise p-type electrochromic materials. In some embodiments, the first electrochromic layer may allow the holes to be injected from the transparent conductive material of the first electrode layer (anode) into the p-type electrochromic material. The injection of holes into the p-type electrochromic material significantly enhances the oxidation of the p-type electrochromic material causing a transformation from a first state (transparent) to a second state (darkened). In some embodiments, the p-type electrochromic materials can comprise anodic materials. The term “anodic electrochromic material” as used herein means a material that undergoes changes in optical properties by an oxidation reaction thereof in which electrons are removed from the material.

The first electrochromic layer may be crystalline or amorphous. In some examples, when the p-type electrochromic material crystalizes it forms a nanostructure or rough surface morphology. In cases where the p-type electrochromic material forms a nanostructured or rough surface morphology, the first electrochromic layer can perform a dual function and operate as both the electrochromic layer and as the buffer layer. When the first electrochromic layer operates in this dual capacity, the nanostructured or rough surface morphology can be transferred through the ultrathin layers of the element and imparted onto the surface of the second electrode layer. In some embodiments, the first electrochromic layer is amorphous or quasi amorphous. Amorphous or quasi amorphous first electrochromic layers may possess better durability under some conditions, in comparison to their crystalline counter-parts. The amorphous or quasi amorphous state of the first electrochromic layer may be obtained by the addition of a second inorganic oxide (additive material) to the electrochromic material. In some embodiments, the second inorganic oxide may be a post-transition metal or a metalloid. It is believed that the addition of a second inorganic oxide to the p-type electrochromic material breaks up the ordered lattice structure of the p-type electrochromic material, preventing the formation of a crystalline morphology. This interference with the lattice structure leads to an amorphous morphology. It is further believed that an amorphous surface stabilizes the first electrochromic layer which in turn leads to improved device performance in certain conditions. It is further believed that by preventing such crystallization of the p-type electrochromic material stabilizes the % T modulation and increases the durability of the film. In some embodiments, the electrochromic material may comprise a p-type (anodic) electrochromic material and an additive, wherein the additive may be an inorganic oxide.

Non-limiting examples of anodic electrochromic materials, e.g., for use in the first electrochromic layer, include nickel oxide (NiO), iridium(IV) oxide (IrO₂), chromium oxide (Cr₂O₅), manganese dioxide (MnO₂), iron oxide (FeO₂), and cobalt(II) peroxide (CoO₂). In some embodiments, the first electrochromic layer comprises nickel oxide.

Some non-limiting additive (or second) inorganic oxides, e.g., for use in the amorphous or quasi amorphous first electrochromic layer, include titanium dioxide (TiO₂), aluminum oxide (Al₂O₃), tungsten oxide (WO₃), copper oxide (CuO), vanadium oxide (V₂O₅), cobalt oxide (CoO), silicon oxide (SiO₂), boron oxide (B₂O₃), and tin oxide (SnO₂). In some embodiments, the first electrochromic layer may comprise nickel-aluminum-oxide. In some embodiments, the first electrochromic layer may comprise nickel-silicon-oxide.

The first electrochromic layer (e.g., a layer comprising nickel-aluminum-oxide (Ni—Al—O) or nickel-silicon-oxide (Ni—Si—O) or another metal oxide with and additive inorganic oxide above) may comprise an atomic ratio of additive inorganic oxide to Ni of about 1:99 to about 1:1, about 1:99 to about 1:49, about 1:49 to about 1:19, or about 1:19 to 1:18, about 1:18 to 1:17, about 1:17 to 1:16, about 1:16 to 1:15, about 1:15 to 1:14, about 1:14 to 1:13, about 1:13 to 1:12, about 1:12 to 1:11, about 1:11 to 1:10, about 1:10 to 1:9, about 1:9 to 1:8, about 1:8 to 1:7, about 1:7 to 1:6, about 1:6 to 1:5, about 1:5 to 1:4, about 1:4 to 1:3, about 1:3 to 1:2, about 1:2 to 1:1, about 1:18, about 1:17, about 1:16, about 1:15, about 1:14, about 1:13, about 1:12, about 1:11, about 1:10, about 1:9, about 1:8, about 1:7, about 1:6, about 1:5, about 1:4, about 1:3, about 1:2, about 1:1, or any ratio bound by the ranges listed herein above. In some embodiments, the first electrochromic layer comprises about 50 to 95% Ni. In some embodiments, the first electrochromic layer comprises about 1 to 50%, about 1-3%, about 3-5%, about 5-10%, about 10-30%, about 30-50%, about 4-6%, or about 5% of the additive (second) inorganic oxide based upon the atom % of the non-oxygen atoms.

The first electrochromic layer (e.g., a layer comprising NiO, NiAlO, NiSiO, or another metal oxide compound above) may have any suitable thickness, such as about 40-500 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 300-350 nm, about 350-400 nm, about 400-450 nm, about 450-500 nm, about 80-100 nm, about 100-125 nm, about 125-150 nm, about 0.1-50 nm, about 50-100 nm, about 100-150 nm, about 0.1-60 nm, about 60-120 nm, about 120-180 nm, about 0.1-100 nm, about 100-300 nm, about 200-400 nm, about 300-500 nm, about 80 nm, about 100 nm, about 125 nm, or about 150 nm. It is believed that in embodiments wherein the first electrochromic layer's morphology is crystalline, the ultrathin layers of the elements and devices described herein are sufficiently thin to allow the transfer of the nanostructured or rough surface morphology therethrough to affect the resultant surface morphology upon the second electrode layer, imparting a template of the nanostructured or rough surface morphology thereon.

The first electrochromic layer (e.g., a layer comprising NiAlO or NiSiO or another metal oxide with and inorganic additive above) may comprise an atomic percentage of additional (second) inorganic oxide from about 5% to 50%, about 10% to about 45%, about 15% to 40% about 20% to 35% about 25% to 30% or about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, or any atomic percentage in a range defined by the approximate values indicated herein above (e.g. about 5-6%, about 5-50%, about 8-15%, about 19-27% etc.), based upon the atom % of the non-oxygen atoms.

The first electrochromic layer comprising the electrochromic material may be fixed to the first electrode layer. The different options for fixing the first electrochromic layer are possible because in this electrochromic layer, at the time of the adjustment of charge imbalance, charge exchange between the electrodes needs only to occur by electron or hole movement through the layers and not by physical movement of the layers themselves.

In some embodiments, the electrochromic element comprises a second electrochromic layer. In some embodiments, the second electrochromic material can include n-type electrochromic materials as discussed above. N-type electrochromic materials allow electrons to be injected from the transparent conductive material of the second electrode layer (cathode). The injection of electrons into the n-type electrochromic material enhances the reduction of the n-type electrochromic material resulting in transformation of the material from a first optical state (transparent) to a second optical state (dark). In some embodiments, the n-type electrochromic materials can comprise cathodic materials. The term “cathodic electrochromic material” as used herein means a material that undergoes changes in optical properties by a reduction reaction thereof in which electrons are given to the material.

Non-limiting examples of cathodic electrochromic materials include tungsten oxide (WO₃), titanium dioxide (TiO₂), niobium oxide (Nb₂O₅), molybdenum (VI) oxide (MoO₃), tantalum(V) oxide (Ta₂O₅), and vanadium pentoxide (V₂O₅). In some embodiments, the second electrochromic layer comprises tungsten oxide.

The second electrochromic layer (e.g., comprising WO₃ or another metal oxide compound in the paragraph above) may have any suitable thickness, such as about 100-800 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 300-310 nm, about 310-320 nm, about 320-330 nm, about 330-340 nm, about 340-350 nm, about 350-360 nm, about 360-370 nm, about 370-380 nm, about 380-390 nm, about 390-400 nm, about 400-410 nm, about 410-420 nm, about 420-430 nm, about 430-440 nm, about 440-450 nm, about 450-460 nm, about 460-470 nm, about 470-480 nm, about 480-490 nm, about 490-500 nm, about 500-550 nm, about 550-600 nm, about 600-650 nm, about 650-700 nm, about 700-750 nm, about 750-800 nm, about 100-300 nm, about 200-400 nm, about 300-500 nm, about 500-700 nm, about 600-800 nm, about 150-250 nm, about 250-350 nm, about 350-450 nm, about 100 nm, about 150 nm, about 200 nm, about 400 nm, or any thickness in a range bounded by any of these values, although other variations are contemplated.

In some embodiments, the second electrochromic layer comprising the electrochromic material may be fixed to the second electrode layer. In some embodiments, the second electrochromic layer comprising the electrochromic material may be fixed to the insulating layer. The different options for fixing the second electrochromic layer to the insulating layer or the second electrode layer are possible because in this layer, at the time of the adjustment of charge imbalance, charge exchange between the electrodes needs only to occur by electron or hole movement through the layers and not by physical movement of the layers themselves. Non-limiting methods of fixing the second electrochromic layer involve, for example, bonding the electrochromic material to the insulating layer through a functional group in a molecule of the electrochromic material, causing the insulating material to retain the electrochromic material in a comprehensive manner (e.g., in a film state) through the utilization of a force, such as an electrostatic interaction, or causing the electrochromic material to physically adsorb to the insulative material of the insulating layer. A method involving chemically bonding a low-molecular weight organic compound serving as the electrochromic material to a porous insulative material through a functional group thereof, or a method involving forming a high-molecular weight compound serving as the electrochromic material on the insulative material may be used when a quick reaction of the electrochromic material is desired. The former method may include fixing the low-molecular weight organic compound serving as the electrochromic material onto a fine particle oxide electrode, such as aluminum oxide, titanium oxide, zinc oxide, or tin oxide, through a functional group, such as an acid group (e.g., a phosphoric acid group or a carboxylic acid group). The latter method is, for example, a method involving polymerizing and forming a viologen polymer on an insulative material and may include electrolytic polymerization. Similar methods are contemplated for fixing the first electrochromic layer to the first electrode, and to the insulating layer.

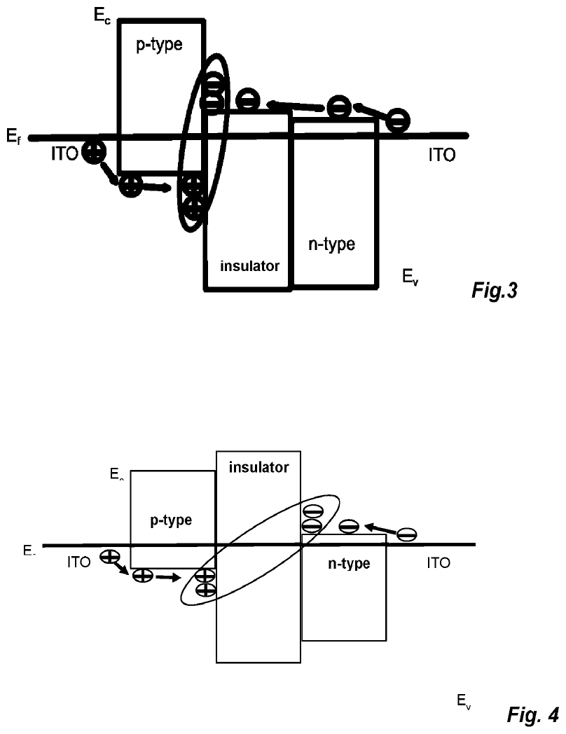

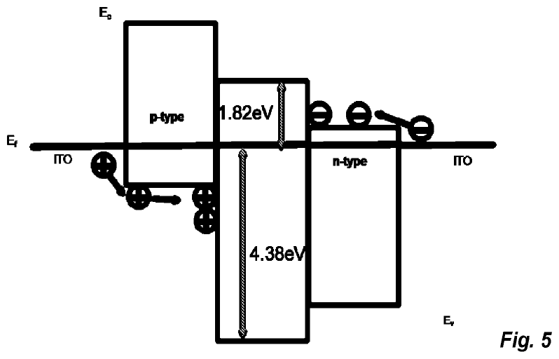

In some embodiments, the electrochromic element comprises an insulating layer. In some embodiments, the insulating layer comprises an electrically insulating material characterized by at least one of a band gap of at least 5 eV, e.g., 8.7 eV (Al₂O₃), 5.6 eV (Y₂O₃), 5.8 eV (HfO₂) and/or 5.8 eV (ZrO₂), a conductance band minimum of at least 2 eV relative to the material's Fermi level, e.g., 8.7 eV (Al₂O₃), 2.8 eV (Y₂O₃), 2.5 eV (HfO₂), and/or 2.36 eV (ZrO₂), or a relative dielectric constant of at least 5 e.g., 9 (Al₂O₃), 15 (Y₂O₃), 25 (HfO₂), and/or 25 (ZrO₂). In the illustrated form (FIGS. 1 and 2), the electrochromic material of the first electrochromic layer is isolated from the electrochromic material of the second electrochromic layer by the insulating layer. In some embodiments, the insulating layer blocks electronic charges (e.g., electrons and holes) from moving through the device from one electrode to the other, while retaining the injected electrons from the cathode within the electrochromic material of the second electrochromic layer, and retaining the injected holes from the anode within the electrochromic material of the first electrochromic layer, for the coloration or darkening of the electrochromic layers. FIG. 3 illustrates the electron drift of the insulating material (Ta₂O₅) with a very low conductance band, relative to the Fermi energy level, thus allowing electrons to penetrate the insulating material. FIG. 4 illustrates the electron blocking of the insulating material (Al₂O₃) with a high conductance band, relative to the Fermi energy level. FIG. 5 illustrates electron blocking of the insulating material (AlN) with a low conductance band, relative to the Fermi energy level. In some embodiments, the insulating layer can reduce or prevent charge leakage between the first and second electrochromic layers. In some embodiments, the insulating layer can increase coloration efficiency. Further, the first electrode layer can also be electrically isolated or separated from the second electrochromic material layer by the insulating layer, which includes an electrically insulative material. The term “electrically insulative” refers to the reduced transmissivity of the layer to electrons and/or holes. In one form, the electrical isolation or separation between these layers may result from increased resistivity within the insulating layer. In addition, it should be appreciated that first electrode can be in electrical communication with the first electrochromic layer, which can be in electrical communication with the insulating layer, which can be in electrical communication with the second electrochromic layer, which can be in electrical communication with the second electrode layer. As indicated above, the insulating layer may include one or more electrically insulative materials, including inorganic and/or organic materials, which exhibit electrically insulative properties. It is believed that the electrically insulative properties of the insulating layer comes from materials with a large “band gap” or “electrical gap” (the energy difference in electron volts (eV) between the top of the valence band and the bottom of the conductive band) and a high conductance band minimum. When the insulative material has a large band gap and high conductance band minimum, very few electrons contain the energy to surmount the electrical gap and to move freely through the insulative material and thus are blocked at the interface of the insulating material and the second electrochromic material. It is believed that this blockage leads to an accumulation of electrons within the second electrochromic layer resulting in higher coloration or darkness efficiency due to the increase in the reduction of the n-type electrochromic materials caused by the excess electrons. It is believed that by using an insulating material having a large band gap and a large conductance band minimum value, the insulating layer blocks electrons from the cathode from passing through the insulating layer, thus trapping the electrons within the second electrochromic layer where they localize and aid in the reduction of the n-type electrochromic material causing a change in the material's optical properties from a first state (transparent) to a second state (dark). It is also believed that the use of the insulative materials with a large band gap block the holes from entering the insulative material, resulting in an accumulation of holes within the p-type electrochromic material, aiding in the oxidation of the p-type electrochromic material and causing a change in the material's optical properties from a first state (transparent) to a second state (dark). It is further believed that the utilization of materials with high dielectric constants result in higher charge storage within the p-type and n-type electrochromic material. It is believed that this increase in the stored charge leads to enhanced reduction of the n-type electrochromic material resulting in a darker second state and enhanced oxidation of the p-type electrochromic materials, also resulting in a darker second state. It is further believed that the higher charge storage results in a lower light transmittance. It is the cumulative effect of blocking both the holes and the electrons from passing into the insulative layer, and increasing the stored charge within the electrochromic layers' materials, that allows for the use of ultrathin layers of p-type electrochromic materials, n-type electrochromic materials, and insulative materials within the electrochromic elements and devices of the present disclosure.

In some embodiments, the insulating layer may be formed, in whole or in part, by oxide, nitride, and/or fluoride compounds. In some examples, the insulating layer may comprise a to metal oxide, a metal nitride, or a metal fluoride compound. Insulating layer compounds may include, for example, aluminum oxide (Al₂O₃), tantalum oxide (Ta₂O₃), yttrium oxide (Y₂O₃), hafnium oxide (HfO₂), calcium oxide (CaO), magnesium oxide (MgO), silicon oxide (SiO₂) and/or zirconium oxide, Si₃N₄, AlN and lithium fluoride. In some embodiments, the insulating layer comprises aluminum oxide, yttrium oxide, hafnium oxide, zirconium oxide or tantalum oxide. In another embodiment, the insulating layer comprises a stoichiometric metal oxide compound, such as TiO₂, SiO₂, WO₃, Al₂O₃, Ta₂O₅, Y₂O₃, HfO₂, CaO, MgO or ZrO₂. In some embodiments, the insulating layer comprising non-stoichiometric metal oxide compounds are also contemplated. In some embodiments, the insulating layer can comprise aluminum oxide (Al₂O₃). In some embodiments, the insulating layer can comprise yttrium oxide (Y₂O₃). In some embodiments, the insulating layer can comprise hafnium oxide (HfO₂). In some embodiments, the insulating layer can comprise zirconium oxide (ZrO₂). In some embodiments, the insulating layer may comprise a doped zirconium oxide. In some embodiments, the insulating layer may comprise a doped silicon oxide (SiO₂). In cases where the insulating layer is doped it may be doped with silicon (Si), aluminum (Al), zirconium (Zr), yttrium (Y) or combinations thereof. In some embodiments, the insulating layer may comprise silicon-aluminum-oxide (Si—Al—O). In some embodiments, insulating layer may comprise zirconium-yttrium-oxide (Zr—Y—O). In some embodiments, the insulating layer may comprise zirconium-aluminum-silicon-oxide (Zr—Al—Si—O). Any material, however, may be used for the insulating layer provided it can block the passage of electrons and holes from one passing out of the respective electrochromic materials.

In some embodiments, wherein the insulating layer comprises a stoichiometric metal oxide compound, the metal oxide compound further comprises a doping material. In some embodiments, the metal oxide doping material can be silicon oxide (SiO₂). In some embodiments, the amount of silicon oxide doped in the metal oxide (e.g. Al₂O₃) can be between 2 wt % to about 40 wt %, about 2-4 wt %, about 4-6 wt %, about 6-8 wt %, about 8-10 wt %, about 10-15 wt % about 15-20 wt %, about 20-25 wt % to about 25-30 wt %, about 30-35 wt %, about 35-40 wt %, about 4-6 wt %, about 15-25 wt % about 20 wt %, about 5 wt %, or any wt % bounded by any of the above ranges of the total weight of metal oxide.

The insulating layer can have any suitable thickness, such as about 40 nm to about 300 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 70-90 nm, about 90-110 nm, about 110-130 nm, about 130-150 nm, about 140-160 nm, about 40-80 nm, about 80-120 nm, about 120-160 nm, about 40-100 nm, about 100-160 nm, about 80 nm, about 100 nm, about 140 nm, about 150 nm, or any thickness in a range bounded by any of these values. In some embodiments, the insulating layer may have a thickness which is less than, equal to, and/or greater than the thickness of the first electrochromic layer or the second electrochromic layer. In some examples, the insulating layer comprises materials and/or structures that are effective in confining, on a selective basis, electrons and/or holes within the adjacent electrochromic layers. It is believed that confining the electrons and/or holes within their respective electrochromic layers can significantly increase the reduction and/or oxidation of the metal oxide electrochromic material leading to a lower percentage of transmittance (T %) at the second (darkened) state.

In some embodiments, the insulating layer may be effective for maintaining (in whole or in part) charges injected in the electrochromic materials of the adjacent electrochromic layers to be stored under a no bias condition; i.e., without continued application of an electric potential.

In some embodiments, the first electrochromic layer may comprise a nanostructured or rough surface morphology. In some embodiments, the nanostructured or rough surface morphology comprises the buffer layer. In some embodiments, the first electrochromic layer can have a dual function by operating as a buffer layer and a p-type electrochromic layer. This dual function of the first electrochromic layer can be achieved by using a suitable annealing process.

In some examples, a buffer layer can be disposed between the first electrode and the first electrochromic layer. In some embodiments, the buffer layer can have a surface comprising a nanostructured or rough morphology. In some embodiments, the buffer layer can have a top surface morphology that is translated through the thin layers (e.g., the first electrochromic layer, the insulating layer, the second electrochromic layer, and the second electrode) disposed on top of the buffer layer. In some examples, the nanostructured template morphology from the buffer layer surface may effect a complementary morphology in the layers deposited thereupon (e.g the insulating layer, the second electrochromic layer, and the second electrode), having a sufficient complementary surface morphology to effect a localized surface plasmon resonance. A phenomenon in which the polarization and an electromagnetic field are combined is referred to as “plasmon resonance.” In particular, a resonance phenomenon that occurs between light and plasma oscillations of free electrons generated on a metal microstructure or a metal particle surface can be referred to as localized surface plasmon resonance (LSPR).

In some embodiments, the buffer layer can comprise a non-polymeric organic compound that may comprise an optionally substituted aromatic ring. In some cases, the buffer layer comprises a bisphenyl pyridine compound. The buffer layer, if present, may include a covalent material such as a metal oxide. One specific but non-limiting example of a suitable metal oxide is Al₂O₃. In some embodiments, the buffer layer can have a thickness between about 0.1 nm to about 50 nm. In some examples, the buffer layer can have a thickness of about 0.1-0.5 nm, about 0.5-1 nm, about 1-1.5 nm, or about 1.5-2 nm; about 2-2.1 nm, about 2.1-2.2 nm, about 2.2-2.3 nm, about 2.3-2.4 nm, about 2.4-2.5 nm, about 2.5-2.6 nm, about 2.6-2.7 nm, about 2.7-2.8 nm, about 2.8-2.9 nm, or about 2.9-3 nm; about 3-3.1 nm, about 3.1-3.2 nm, about 3.2-3.3 nm, about 3.3-3.4 nm, about 3.4-3.5 nm, about 3.5-3.6 nm, about 3.6-3.7 nm, about 3.7-3.8 nm, about 3.8-3.9 nm, about 3.9-4 nm, about 4-4.1 nm, about 4.1-4.2 nm, about 4.2-4.3 nm, about 4.3-4.4 nm, about 4.4-4.5 nm, about 4.5-4.6 nm, about 4.6-4.7 nm, about 4.7-4.8 nm, about 4.8-4.9 nm, or about 4.9-5 nm; about 5-5.1 nm, about 5.1-5.2 nm, about 5.2-5.3 nm, about 5.3-5.4 nm, about 5.4-5.5 nm, about 5.5-5.6 nm, about 5.6-5.7 nm, about 5.7-5.8 nm, about 5.8-5.9 nm, about 5.9-6 nm, about 6-6.5 nm, about 6.5-7 nm, about 7-7.5 nm, about 7.5-8 nm, about 8-9 nm, about 9-10 nm, about 10-15 nm, about 15-20 nm, about 20-30 nm, about 30-40 nm, about 40-50 nm, or about 1 nm, about 2 nm, about 3 nm, about 4 nm, about 5 nm, or about 6 nm, or about any thickness in a range bounded by any of these values.

As detailed above, second electrochromic layer comprises an electrochromic material. In some embodiments, the electrochromic material may include an electrochromic compound and a matrix material. In one particular, but non-limiting, form the electrochromic material includes a metal oxide such as WO₃. However, it should be appreciated that the electrochromic layers can include any electrochromic material or compound that changes optical transmittance and/or absorption when, for example, an insulating (or blocking, barrier) layer is present, it is in a charged-state that can be achieved by, for example, the charged injection from an electrode layer into the second electrochromic layer under an applied voltage pulse above a critical value.

In some embodiments, the electrochromic device can comprise a protection layer. In some embodiments, the protection layer can comprise a polymer or other material to protect the electrochromic device from moisture, oxidation, physical damage, etc. Any suitable protective layer/material, such as those known in the art may be utilized.

It is contemplated that the electrochromic elements and devices herein could be used for a number of different purposes and applications. In one non-limiting form, for example, the electrochromic elements and devices herein could be used in a window member that includes a pair of transparent substrates with the electrochromic elements and devices described herein positioned between said transparent substrates. Owing to the presence of the electrochromic element or device of the present disclosure, the window member can adjust the quantity of light transmitted through the window member bearing the transparent substrates. In addition, the window member can include a frame which supports the electrochemical element or device of the current disclosure, and the window member can be used in an aircraft, an automobile, a house, or the like, just to provide a few possibilities. In some embodiments, the window member comprising the electrochemical element or device of the present disclosure can effect a difference in the transmission of light therethrough of at least 10%, at least 20%, at least 30%, at least 40%, at least 45%, at least 50%, at least 55%, at least 60%, at least 65%, at least 70%, at least 75%, at least 80%, at least 85%, at least 90%, at least 95%, about 10-30%, about 30-50%, about 50-70%, about 70-85%, about 85-95%, or about 95%-100%, between the off and on state at a selected wavelength in the visible range of light.

In some embodiments, activation of or turning on the electrochromic materials of the first electrochromic layer and the second electrochromic layer involves injecting holes into the first electrochromic layer while electrons are injected into the second electrochromic layer as the second electrode is held at a ground potential and a positive voltage is applied to the first electrode. When a forward DC voltage bias is applied to the device (the electrical potential of the first electrode is higher than the second electrode), holes are injected from the first electrode into the p-type electrochromic layer resulting in coloration or decreasing its transparency (T %), while electrons injected from the second electrode into the n-type electrochromic layer, resulting in coloration or decreasing its transmittance (T %). When a reversed voltage bias is applied to the device (the electrical potential of the second electrode is higher than the electrical potential of the first electrode), electrons removed from the n-type electrochromic layer and holes removed from the p-type electrochromic layer, resulting in discoloration or increasing the light transmittance (T %). The applied DC electrical voltage can be from 0.1V up to 5V or higher depending on how the device is made.

While operation of the present disclosure has been described principally in connection with the electrochromic devices described herein, it is believed that the operating principles of the electrochromic devices and electrochromic elements described herein are the same. In FIG. 2, a voltage pulse is applied to the first electrode and the second electrode. Since the device is insulated under normal operation, the applied voltage pulse is only needed for switching states of the first electrochromic material of the first electrochromic layer and second electrochromic material of the second electrochromic layer. Further, as indicated above, electron and/or hole conduction may only occur upon application of a critical voltage pulse necessary to push electrons and/or holes into or out of the electrochromic material of the electrochromic layers. Moreover, given that the device is insulated under normal operation and the electrochromic material of the electrochromic layers is insulated from the electrodes and/or holes, the leakage of charges into or out of the electrochromic material is reduced, minimized, or eliminated.

The insulating effect of the insulating/blocking layer of the present disclosure may provide a wide band gap insulating effect, while the electrochromic layers have a lower-level conduction band that can keep the electron[s] trapped therein as the “memory” effect (non-volatile), which reduces, minimizes and/or insures no power consumption under normal device operation unless a switching process is occurring. Similarly, this arrangement can reduce, minimize and/or eliminate the issue of leakage suffered in other forms of electrochromic devices. In addition, the insulative properties of the devices described herein allow the voltage applied from the power supply to the electrochromic material of electrochromic layers to be uniformly applied without a potential drop to the electrode, since the resistance of the device is much larger than the resistance of the electrode. Other forms of an electrochromic device may generally be highly conductive and, in applications for a larger area such as a window, the device has a much lower resistance and the electrode layer's resistance can be comparable to or less than the device's resistance. This may result in a drop across the electrode layer, which may cause non-uniformity in application of the power supply for applications of these devices in larger area applications. In contrast, as indicated above, it is believed the electrochromic elements and electrochromic devices of the present disclosure may be effective for minimizing, reducing or eliminating the occurrence of this issue.

In some embodiments of the present disclosure, the electrochromic material of the electrochromic layer can trap both electrons and holes. When a voltage pulse is supplied to the two electrodes above a critical value, the large band gap of the insulating layer may cause electron injection from the cathode electrode into the electrochromic material of second electrochromic layer and hole injection from the anode into the first electrochromic layer. The charges will be stored in the respective electrochromic layers due to the insulative effect provided by the insulating layer. The stored charges in the electrochromic material of electrochromic layers may cause a color change or a change in transmission/absorption. For example, it may cause a change from a first state that is clear to a second state that has high absorption (darkened).

Deactivation of or turning off the electrochromic material of first and the second electrochromic layers involves the inverse of the activation/turning on procedure. For example, if the electrochromic material of second electrochromic layer is activated/turned on by supplying a positive voltage to the first electrode, the deactivation/turning off operation involves supplying a negative voltage of about the same magnitude to the second electrode while the source electrode is held at a ground potential. Alternatively, if the electrochromic material of electrochromic layer is activated by supplying a negative voltage to the second electrode, the deactivation/turning off operation involves supplying a positive voltage of about the same magnitude to the control gate/gate electrode while the source electrode and drain electrode are held at a ground potential.

Some embodiments include a method for preparing an electrochromic element. In some embodiments, the method can comprise providing: a first electrode layer comprising a transparent conductive material; a first electrochromic layer comprising a p-type electrochromic material deposited upon and in electrical communication with the first electrode layer; an insulating layer comprising an electrically insulating material deposited upon and in electrical communication with the first electrochromic layer; a second electrochromic layer comprising a n-type electrochromic material deposited upon and in electrical communication with the insulating layer; and a second electrode layer comprising a transparent conductive material deposited upon and in electrical communication with the second electrochromic layer. In some embodiments, the method further includes a buffer layer positioned between the first electrode and the first electrochromic layer. In some embodiments, the second electrode layer has a nanostructure surface morphology. In some examples, the nanostructure surface morphology of the second electrode is derived from the nanostructure surface morphology of the buffer layer. In some embodiments, the nanostructure surface morphology of the second electrode is imparted by the nanostructure surface morphology of the p-type electrochromic material of the first electrochromic layer. In some embodiments of the method, the p-type electrochromic material with a nanostructure surface morphology operates as both the buffer layer and as the first electrochromic layer. In other embodiments of the method, the second electrode layer can have a thickness between about 10 nm to about 500 nm to allow the transfer of the nanostructure surface morphology from the buffer layer (or first electrochromic layer), imparting a complementary nanostructured surface morphology onto the transparent conductive material.

In some embodiments, the method for preparing an electrochromic device can comprise providing: a first electrode layer comprising a transparent conductive material; a first electrochromic layer comprising a p-type electrochromic material combined with an additive comprising an inorganic oxide deposited upon and in electrical communication with the first electrode layer; an insulating layer comprising an electrically insulating material deposited upon and in electrical communication with the first electrochromic layer; a second electrochromic layer comprising a n-type electrochromic material deposited upon and in electrical communication with the insulating layer; and a second electrode layer comprising transparent conductive material with a nanostructure surface morphology deposited upon and in electrical communication with the second electrochromic layer. In some embodiments of the method, the p-type electrochromic material of the first electrochromic layer may have an amorphous morphology. Some embodiments include further comprising electrically connecting the transparent conductive material of the first electrode layer and the transparent conductive material of the second electrode layer to a power source, wherein the first electrode layer and the second electrode layer are in electrical communication. In some examples, the method for preparing an electrochromic device includes the preparation of the electrochromic element described above, further comprising a power source in electrical communication with the first and second electrodes.

Some embodiments include a method for preparing an electrochromic device, wherein the method can further comprise encapsulating the device with an optically transparent encapsulation material. The optically transparent encapsulating material can limit or prevent exposure of the electrochromic device to oxygen; e.g., not allowing or greatly reducing the exposure of the device to atmospheric oxygen. The choice of encapsulating material is not limiting, and one skilled in the art of electrochromic devices could choose any appropriate encapsulating material.

### Embodiments

Embodiment 1. An electrochromic element comprising:
   a first electrode layer, wherein the first electrode layer comprises a transparent conductive material;
   a first electrochromic layer, wherein the first electrochromic layer comprises a p-type electrochromic-based composite comprising a p-type electrochromic material and an additive comprising an inorganic oxide, and wherein the second electrochromic layer is in electrical communication with the first electrode layer;
   an insulating layer, wherein the insulating layer comprises an electrically insulating material with a band gap at least 5 eV and a conductance band edge with a minimum of 2 eV relative to the materials Fermi level and wherein the electrically insulating material is in electrical communication with the first electrochromic layer;
   a second electrochromic layer, wherein the second electrochromic layer comprises a n-type electrochromic material and is in electrical communication with the insulating layer; and
   a second electrode layer, wherein the second electrode layer comprises a transparent conductive material and wherein the second electrode layer is in electrical communication with the second electrochromic layer.
Embodiment 2. The electrochromic element of embodiment 1, wherein p-type electrochromic material comprises an anodic material.
Embodiment 3. The electrochromic element of embodiment 1 or 2, wherein the inorganic oxide is a post transition metal.
Embodiment 4. The electrochromic element of embodiment 3, wherein the post transition metal is Al.
Embodiment 5. The electrochromic element of embodiment 1, 2, 3, or 4, wherein the inorganic oxide is a metalloid.
Embodiment 6. The electrochromic element of embodiment 5, wherein the metalloid is silicon.
Embodiment 7. The electrochromic element of embodiment 1, 2, 3, 4, 5, or 6, wherein the first electrochromic layer is amorphous.
Embodiment 8. The electrochromic element of embodiment 1, 2, 3, 4, 5, 6, or 7, wherein the first electrochromic layer comprises about 50 to about 95 atomic % of Ni.
Embodiment 9. The electrochromic element of embodiment 1, 2, 3, 4, 5, 6, 7, or 8, wherein the first electrochromic layer comprises about 5 to about 50 atomic % of the additive inorganic material.
Embodiment 10. The electrochromic element of embodiment 1, 2, 3, 4, 5, 6, 7, 8, or 9, wherein the first electrochromic material further comprised an oxide.
Embodiment 11. The electrochromic element of embodiment 1, 2, 3, 4, 5, 6, 7, 8, 9, or 10, wherein the p-type electrochromic-based composite comprises nickel, aluminum, and oxygen.
Embodiment 12. The electrochromic element of embodiment 1, 2, 3, 4, 5, 6, 7, 8, 9, 10, or 11, wherein the n-type electrochromic material comprises tungsten oxide.
Embodiment 13. The electrochromic element of embodiment 1, wherein the electrically insulating material comprises an oxide, nitride or a fluoride compound.
Embodiment 14. The electrochromic element of embodiment 13, wherein the electrically insulating material comprises of a metal oxide compound.
Embodiment 15. The electrochromic element of embodiment 13 or 14, wherein the metal oxide compound is aluminum oxide, silicon-aluminum-oxide, zirconium oxide and/or zirconium-yttrium-oxide.
Embodiment 16. The electrochromic element of embodiment 13, 14 or 15, wherein the metal oxide compound is silicon-aluminum-oxide.

### Examples

It should be appreciated that the following Examples are for illustration purposes and are not intended to be construed as limiting the subject matter disclosed in this document to only the embodiments disclosed in these examples.

### Preparing Electrochromic Device CE-1

A pre-learned patterned ITO-glass substrate (first electrode) was loaded onto a sputtering vacuum deposition chamber (Angstrom Engineering, Inc.) set at 2×10⁻⁷ torr. First, a NiO (100 nm) p-type, electrochromic layer was deposited through a sputtering process under vacuum of 2×10⁻⁷ torr, from a Ni target under a working gas of Ar—O₂, where O₂ concentration was set at 30% with a deposition rate of 2 Å/s. Next, a Si—Al₂O₃ (100 nm) insulation layer was deposited through a sputtering process under vacuum of 2×10⁻⁷ torr, from a Si(5%)/Al target, where the O₂ concentration was set at 15% with a deposition rate of 3 Å/s. Next, a WO₃ (200 nm) n-type, electrochromic layer was deposited via a sputtering process under vacuum of 2×10⁻⁷ torr, from a W target under a working gas of Ar:O₂, where O₂ concentration was set at 35% with a deposition rate of 3 Å/s. Next, the ITO electrode (second electrode/cathode) was deposited using RF sputtering under Ar processing gas at a deposition rate of 1.5 Å/s. Electrical connections were connected between a power source (Tektronix, Inc., Beaverton, Oreg., USA, Keithley 2400 source meter) and switched electrical connections with the electrodes to enable selective application of potential to the first electrode (on) or to the bottom or second electrode (off).

The devices of Examples, EC-1 and EC-2 were made in a manner similar to that described above with respect to the device of Example CE-1, except the thermal vacuum deposition chamber were set at less than 1×10⁻⁶ torr, and the p-type first electrochromic layer varied as indicated in Table 2 below. The Al—Ni—O layer was deposited through reactive sputtering of Al(5%)Ni target under Ar and oxygen mixture as processing gas. The Si—Ni—O layer was deposited through reactive sputtering of Si(5%)Ni target under Ar and oxygen mixture as processing gas.

TABLE 2
Electrochromic Devices

| | | | | | | Nano- | |
|---|---|---|---|---|---|---|---|
| | | First | First Electro- | Insulating | Second Electro- | particle | Second |
| Example | Substrate | Electrode | chromic layer | layer | chromic layer | layer | Electrode |
| CE-1 | Glass | ITO | NiO | Si (5%)- | WO₃ | None | ITO |
| | | | (100 nm) | Al₂O₃ | (200 nm) | | (80 nm) |
| | | | | (100 nm) | | | |
| EC-1 | Glass | ITO | Al (5%) NiO | Si (5%)- | WO₃ | None | ITO |
| | | | (100 nm) | Al₂O₃ | (200 nm) | | (80 nm) |
| | | | | (100 nm) | | | |
| EC-2 | Glass | ITO | Si (5%) NiO | Si (5%)- | WO₃ | None | ITO |
| | | | (80 nm) | Al₂O₃ | (200 nm) | | (80 nm) |
| | | | | (100 nm) | | | |

### Transmissive (T %)

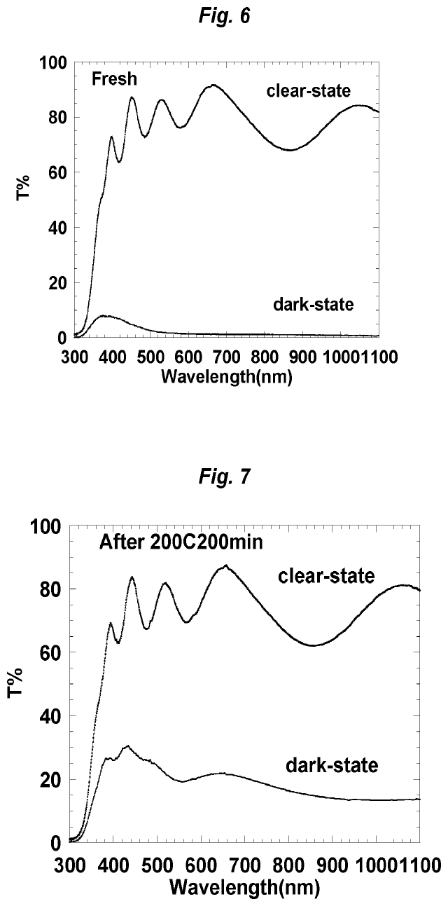

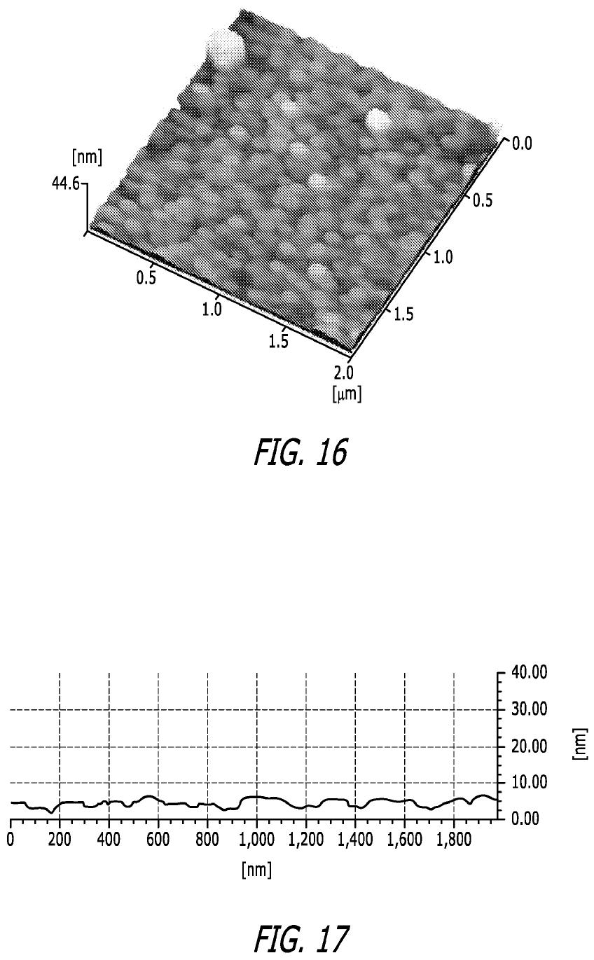

In addition, total light transmittance data of the examples were measured by using the measurement system like that described in U.S. Pat. No. 8,169,136 (shown there and described in FIG. 16 of U.S. Pat. No. 8,169,136 (MCPD 7000, Otsuka Electronics, Inc., Xe lamp, monochromator, and integrating sphere equipped)). FIGS. 6-11 show the total light transmittance spectrum of the ON state and OFF state of embodiments tested, e.g., Samples CE-1, EC-1 and EC-2.

The Example CE-1 device as described herein was positioned onto a Filmetrics F10-RT-YV reflectometer (Filmetrics, San Diego, Calif., USA), and the total transmission therethrough (T %) for ON state and OFF state was determined over varying wavelengths of light.

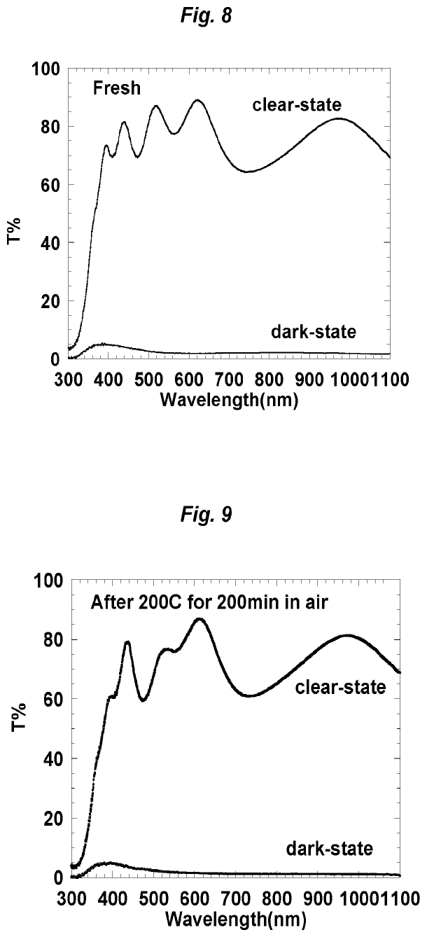

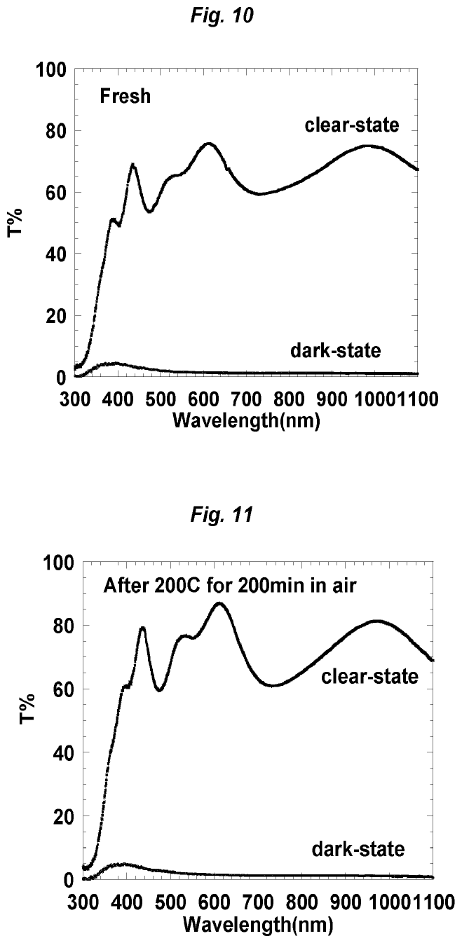

The T % ON state and OFF state for fresh and accelerated aged (see below) devices with CE-1, EC-1, and EC-2, are shown in FIGS. 6-7 (CE-1), 8-9 (EC-1), and 10-11 (EC-2). At 630 nm, they showed a difference between on and off state T %, at 630 nm of 67.2% (FIG. 6, CE-1 fresh); of 48.9% (FIG. 8, fresh EC-1); of 55.6% (FIG. 10, fresh EC-2); of 3.9% (FIG. 1, accelerated aging CE-1); of 50.5% (FIG. 9, accelerated aging EC-1); of 59.3% (FIG. 11, accelerated aging EC-2). As shown, the embodiments of a p-type electrochromic material in combination with an additive inorganic oxide show improvement over the comparative embodiment. Furthermore, the embodiments show that EC-1 and EC-2 show little degradation due to aging over the comparative example, thus indicating that the amorphous surface can improve device durability over a crystalline surface.

### Accelerated Stability Test

Accelerated stability tests the devices durability over long periods. The accelerated stability tests speed up the degradation of electrochromic devices materials by increasing the temperature to 200° C. Accelerated stability tests were performed on bare device, (devices that are not encapsulated, sealed edges). Fresh bare devices baseline transmission percent (T %) readings were taken, as described above. The fresh devices were then placed in a VWR Forced Air Oven (WVR International Co., Radnor Pa., USA), set at 200° C., normal atmosphere, for 200 minutes. After exposure to 200° C. at normal atmosphere for 200 minutes, the device's T % was read at 630 nm, and recorded (see Table 3 below). The difference between the baseline T % read, and the 200 minutes at 200° C. exposed T % read, were compared. If the device experienced significant insulating layer failure, the OFF/ON ratio (the difference between the off state and the on state T %) will be significantly different from the OFF/ON ratio of the device exposed to 200° C. for 200 minutes.

TABLE 3

| | Fresh T % @ 630 nm at room | | | 200° C.-200 min. | | | Heat durability | |
|---|---|---|---|---|---|---|---|---|
| | temperature at 630 nm | | | T % @ 630 nm | | | (OFF/ON ratio change) | |
| # | OFF | ON | OFF/ON | OFF | ON | OFF/ON | Absolute | relative |
| CE-1 | 87.4 | 1.3 | 67.2 | 84.4 | 21.7 | 3.9 | 5.8% | 1 |
| EC-1 | 88 | 1.8 | 48.9 | 89 | 3.6 | 24.7 | 50.5% | 8.7 X |
| EC-2 | 73.9 | 1.33 | 55.6 | 84.2 | 1.42 | 59.3 | 107% | 18 X |

Based on these results, it can be seen that the T % for the devices EC-1 and EC-2 show little change over time as compared with CE-1. The addition of the p-type EC material and an additive second inorganic oxide resulting in an amorphous surface morphology lead to devices with little to no change in performance over time when compared to the p-type alone electrochromic material (which results in a nanostructured surface morphology). It also appears from these results that the nanostructured surface morphology changes over time, and this may be due to the crystalline structure changing with age.

### Surface Analysis Test

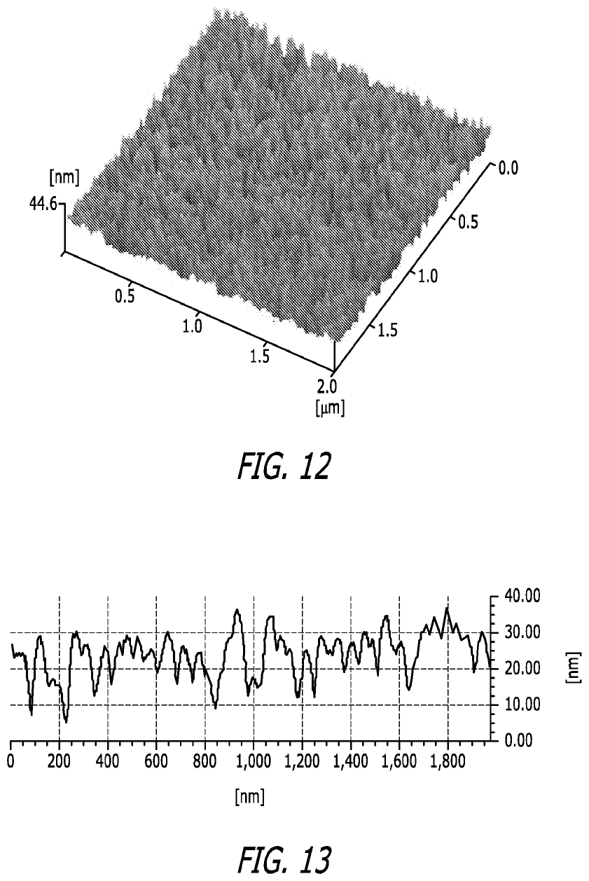

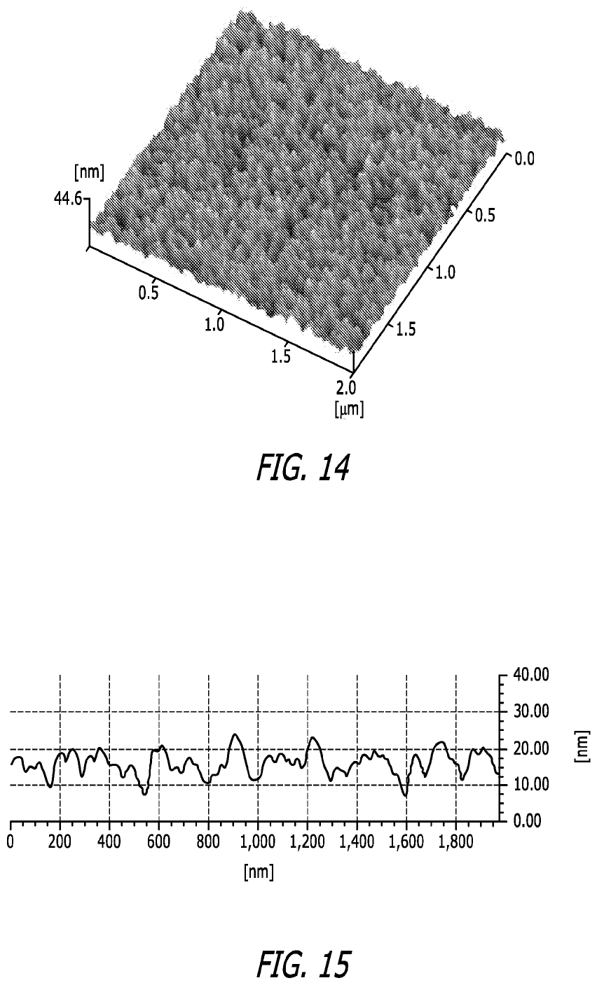

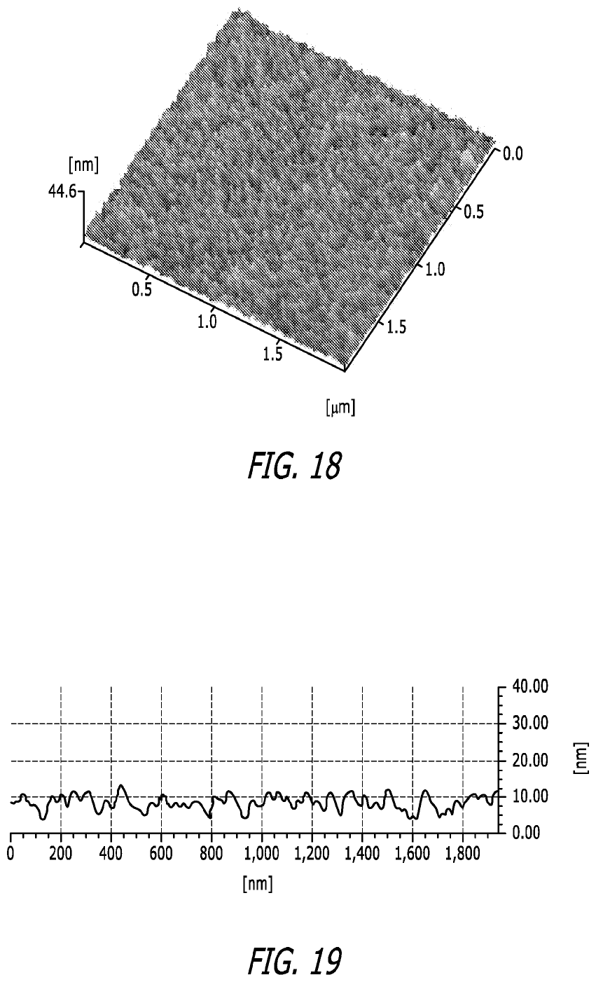

Surface analysis tests the morphology of film. All surface analysis was performed on fresh and 2 week old samples using an Atomic Force Microscopy (AFM) (AFM5300E, Hitachi High Technologies Corporation, Tokyo, Japan). The AFM was run on tapping mode with a cantilever prove. The force constant for the prove was set to 40 N/m. The scanning area of the film samples were 2 μm×2 μm in the x/y plane. FIGS. 12 and 13 illustrate the surface morphology of fresh CE-1, they illustrate the nanorough surface of the crystalline surface of the p-type electrochromic material. FIGS. 13 and 14, illustrate the surface morphology of two-week old CE-1. FIGS. 12 and 14 illustrate the change in the nanorough surface morphology of CE-1. FIGS. 13 and 15 show the change in graphic detail the peaks and valleys associated with CE-1's crystalline surface. FIGS. 16 and 18 illustrate the negligible change in the amorphous surface morphology of EC-1. FIGS. 17 and 19 show negligible changes in graphic detail EC-1's amorphous surface. By comparing the maximum peak valley difference (the difference between the highest peak and the lowest valley within the sample) and the root mean square roughness (RMS) of CE-1 and EC-1 over time, see Table 4, it is apparent that CE-1's nanorough surface changes as it ages, while EC-1's amorphous surface remains relatively unchanged over time. The maximum peak valley is automatically calculated by the AFM and the RMS is calculated using the equation:

$${R}_{q} = \sqrt{\frac{1}{L} {{\int }^{L}}_{0} \vert {Z}^{2} ( x ) \vert dx} ,$$

wherein R_{q} is the RMS roughness, Z(x) is the surface profile function of height (Z) and position (x), and L is the evaluation length.

TABLE 4

| | Surface Roughness (nm) | | | | | |
|---|---|---|---|---|---|---|
| | Fresh | | 1 weeks | | 2 weeks | |
| | | Peak | | Peak | | Peak |
| # | RMS | Valley | RMS | Valley | RMS | Valley |
| CE-1 | 10.5 | 41 | 6.1 | 26 | 3.3 | 12.6 |
| EC-1 | 1.0 | 4 | | | 1.4 | 5.8 |
| EC-2 | | | | | | |

These results confirm the belief that the crystalline nanostructured morphology is changing over time and that an amorphous surface morphology has little to no change resulting in a more durable and reliable device overtime.

For the processes and/or methods disclosed, the functions performed in the processes and methods may be implemented in differing order, as may be indicated by context. Furthermore, the outlined steps and operations are only provided as examples, and some of the steps and operations may be optional, combined into fewer steps and operations, or expanded into additional steps and operations.

This disclosure may sometimes illustrate different components contained within, or connected with, different other components. Such depicted architectures are merely examples, and many other architectures can be implemented which achieve the same or similar functionality.

The terms used in this disclosure, and in the appended embodiments, are generally intended as “open” terms (e.g., the term “including” should be interpreted as “including, but not limited to,” the term “having” should be interpreted as “having at least,” the term “includes” should be interpreted as “includes, but is not limited to,” etc.). In addition, if a specific number of elements is introduced, this may be interpreted to mean at least the recited number, as may be indicated by context (e.g., the bare recitation of “two recitations,” without other modifiers, means at least two recitations, or two or more recitations). As used in this disclosure, any disjunctive word and/or phrase presenting two or more alternative terms should be understood to contemplate the possibilities of including one of the terms, either of the terms, or both terms. For example, the phrase “A or B” will be understood to include the possibilities of “A” or “B” or “A and B.”

The terms and words used are not limited to the bibliographical meanings but are merely used to enable a clear and consistent understanding of the disclosure. It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

Aspects of the present disclosure may be embodied in other forms without departing from its spirit or essential characteristics. The described aspects are to be considered in all respects illustrative and not restrictive. The subject matter of the present disclosure is indicated by the appended embodiments rather than by the foregoing description. All changes, which come within the meaning and range of equivalency of the embodiments, are to be embraced within their scope.

1. An electrochromic element comprising:
a first electrode layer, wherein the first electrode layer comprises a transparent conductive material;
a first electrochromic layer, wherein the first electrochromic layer comprises a p-type electrochromic-based composite comprising a p-type electrochromic material and an additive inorganic oxide, and wherein the first electrochromic layer is in electrical communication with the first electrode layer;
an insulating layer, wherein the insulating layer comprises an electrically insulating material with a band gap at least 5 eV and a conductance band edge that is at least 2 eV higher than the material's Fermi level, and wherein the electrically insulating material is in electrical communication with the first electrochromic layer;
a second electrochromic layer, wherein the second electrochromic layer comprises an n-type electrochromic material and is in electrical communication with the insulating layer; and
a second electrode layer, wherein the second electrode layer comprises a transparent conductive material, and wherein the second electrode layer is in electrical communication with the second electrochromic layer.

2. The electrochromic element of claim 1, wherein the p-type electrochromic material comprises an anodic material.

3. The electrochromic element of claim 1, wherein the additive inorganic oxide comprises a post-transition metal.

4. The electrochromic element of claim 3, wherein the post-transition metal is Al.

5. The electrochromic element of claim 1, wherein the additive inorganic oxide comprises a metalloid.

6. The electrochromic element of claim 5, wherein the metalloid is silicon.

7. The electrochromic element of claim 1, wherein the first electrochromic layer is amorphous.

8. The electrochromic element of claim 1, wherein the first electrochromic layer comprises about 50 atomic % to about 99 atomic % of Ni based upon the number of non-oxygen atoms.

9. The electrochromic element of claim 1, wherein the first electrochromic layer comprises about 1 atomic % to about 50 atomic % of the additive inorganic oxide based upon the number of non-oxygen atoms.

10. The electrochromic element of claim 1, wherein the p-type electrochromic-based composite comprises nickel, aluminum, and oxygen.

11. The electrochromic element of claim 1, wherein the p-type electrochromic-based composite comprises nickel, silicon, and oxygen.

12. The electrochromic element of claim 1, wherein the n-type electrochromic material comprises tungsten oxide.

13. The electrochromic element of claim 1, wherein the electrically insulating material comprises a metal oxide, a metal nitride or a metal fluoride compound.

14. The electrochromic element of claim 13, wherein the electrically insulating material comprises an insulative metal oxide compound.

15. The electrochromic element of claim 13, wherein the insulative metal oxide compound is aluminum oxide, silicon-aluminum-oxide, zirconium oxide and/or zirconium-yttrium-oxide.

16. The electrochromic element of claim 13, wherein the insulative metal oxide compound is silicon-aluminum-oxide.

17. The electrochromic element of claim 1, wherein the first electrochromic layer has a thickness of about 80 nm to about 100 nm.

18. The electrochromic element of claim 1, wherein the transparent conductive material of the first electrode layer and the second electrode layer comprises a conductive metal oxide.

19. The electrochromic element of claim 18, wherein the conductive metal oxide is indium tin oxide (ITO).

20. The electrochromic element of claim 1, wherein the second electrode layer has a thickness of about 10 nm to about 150 nm.
